(19) United States
(12) Patent Application Publication
(10) Pub. No.: US 2006/0218184 A1
(43) Pub. Date: Sep. 28, 2006

(54) Method of searching for media objects

(76) Inventors: Holger R. Scholl, Herzogenrath (DE); Eric Thelen, Aachen (DE); Jan Kneissler, Aachen (DE); Andreas Kellner, Aachen (DE)

Correspondence Address: PHILIPS INTELLECTUAL PROPERTY & STANDARDS, P.O. BOX 3001, BRIARCLIFF MANOR, NY, 10510, US

(21) Appl. No.: 10/556,002

(22) PCT Filed: May 5, 2004
(86) PCT No.: PCT/IB04/50584

§ 371 Date: Nov. 8, 2005

(30) Foreign Application Priority Data
May 12, 2003 (EP) 03101309.7

(51) Int. Cl. G06F 17/00

(52) U.S. Cl. 707/104.1

(57) ABSTRACT

A method of searching for media objects is described, in which, in order to establish degrees of correspondence (UG) between a search request (SA) and selectable media objects, at least one feature (i1, d1, d11, d12) of the search request is compared with at least one feature of the selectable media objects, in which the search request comprises at least one representation-describing feature (d1), and in which a search result based on the degrees of correspondence (UG) is organized. In addition, a corresponding system of searching for media objects is described.

The invention relates to a method and a system of searching for media objects.

The offering in respect of various electronic media types and formats has been increasing extremely rapidly, especially just recently. There therefore exists an increasing need for suitable methods of enabling a user to search for media content within this increasing offering. Owing to the diversity of the offering and the various options for using media content, a search for media objects in various environments may be desired hereby. Examples of this would be a search for media objects that are stored locally, at home, on the user's personal computer or home entertainment system, a search for media objects that are stored on Internet servers with worldwide distribution, or a search for media objects stored on the server of an Internet shop for media objects.

The term “media object” hereby refers to any type of media content, especially text content, audio content and/or visual content, such as films, shows, news, radio dramas, music, pictures or personalized Internet content. These media objects, preferably in digital form, may hereby be available in stored form, be retrievable as “audio on demand” or “video on demand”, or be generated in real time as “live content”. The term “media object” hereby includes both whole, self-contained units, such as whole films or whole news broadcasts, and parts of these whole units, such as film sequences or parts of news broadcasts.

A search method that is generally known consists of sending a search request from a personal computer to an Internet search engine. A search request of this kind could contain, for instance, the name of a music group. The name of the music group is hereby a way of describing the content of the media object “piece of music” being sought. A different way of describing the content of the media object “piece of music” being sought would be, for instance, stating the title of a piece of music, a passage of text from the piece of music or the name of a relevant music CD or record. The Internet search engine then compares the name of the music group with names of music groups with which pieces of music are associated, stored in a directory. The name of the music group that best corresponds with the name of the music group sought is then established. Finally, a search result is sent to the personal computer by the Internet search engine in the form of a list of pieces of music associated with this established music group.

However, this known way of searching, the core of which comprises a comparison of features of a search request describing the content of the media object with stored features describing the content of the available media objects, proves to have considerable disadvantages in practice. For instance, the search result frequently comprises media objects which, although they are related in some way to the content-describing feature of the search request, do not accord with the user's personality profile and/or what the user actually had in mind. It is then left to the user to pick out from the large number of media objects found the ones that correspond to his actual wishes and preferences—for guitar-oriented rock music, for instance. This may involve a high input in terms of cost and time.

If, for instance, a doctor is searching for scientific articles concerning lung diseases, and sends a related search request with the content-describing feature “lung disease” to an Internet search engine, he will receive as the search result an enormous number of articles which, although they exhibit in their content a certain correspondence with the term “lung disease”, are not scientific articles, as actually sought by the doctor. As the user, the doctor then laboriously has to pick out the scientific articles from the large number of articles found, by looking at the articles individually. A logic “AND” operation of the content-describing feature “lung disease” with the content-describing feature “scientific” for use in a search request generally does not confer any advantage, since scientific articles are not generally identified with the headword “scientific”.

It is therefore an object of the present invention to provide a method of searching for media objects that enables the user to search conveniently and reliably for media objects that correspond to his personality profile and/or his personal wishes.

This object is achieved by a method of the type specified above, in which, in order to establish degrees of correspondence between a search request and selectable media objects, at least one feature of the search request is compared with at least one feature of the selectable media objects, wherein the search request comprises at least one representation-describing feature, and in which a search result based on the degrees of correspondence is organized.

The degree of correspondence between a search request and a media object may hereby depend, in particular, on the number of corresponding features, the relevance of the corresponding features, the in particular user-specific prioritization of the corresponding features and/or the degree of correspondence of the features compared with one another.

The selectable media objects may hereby be stored centrally in a database or may be distributed in multiple databases. It is also possible for the media objects to be stored locally in a memory facility at the user's location, or remotely in a memory facility connected to the user via a communications connection. The individual steps of the search method may also be implemented by the user centrally, with distribution, locally at the user's location or remotely.

The term representation-describing features, which may also be referred to as representation-specific attributes or perception features, hereby relates to all features that describe the representation of a media object. By means of representation-describing features of this kind, a media object may be more accurately specified, by way of supplementation or as an alternative to the content description, so that the search may be even better tailored to the user's wishes. Depending on the type of media object, different representation-describing features are possibilities hereby, some of which will be briefly explained below by way of example:

the representation of Internet sites may be described by, for instance, the number of pictures contained in the Internet site or by the type of layout (clear and concise or full of information);

the representation of news of or a radio program may be described by, for instance, the type of voice of the speaker (male or female, high, low or sonorous);

the representation of recorded pieces of music may be described by, in particular, the recording quality (hi-fi, tape noise, radio receiver noise or noise occasioned by the operation of the recording button);

the representation of documentary material may be described by the type of language used (childish language or adult language);

the representation of films may advantageously be described by the frequency of the cuts, contrast changes, color distribution, the speed of movement or of language, by expressions used or actions occurring (explosions, scenes of nudity or violence, pornography);

the representation of audio content may be described by the change in volume used, the effects included (stereo or surround), the presence of certain language (processing) features, the rate of speech, the articulation or the existence of delays;

the representation of pieces of music may be described by the music genre, the music style or the instruments used;

the representation of text objects may also be described by layout characteristics, the style of language used or, in the case of scientific texts for example, by the presence of bibliographical references, of a separate summary or of an introductory piece on the author.

An organization of a search result may be implemented by, in particular, the selection of media objects with a particularly high degree of correspondence and/or by the sorting of the media objects found as a function of their degree of correspondence. In accordance with one embodiment of the invention, these media objects, selected and/or sorted in this way, or the corresponding titles, may then be offered to a user, e.g. on a display device, for manual selection by the user.

It is therefore achieved by means of the invention that, in response to a search request, the user is offered as the search result, exclusively and/or preferably, those media objects that best correspond with his search request in terms of the requested representation-describing features, and thereby best satisfy his personal wishes. Since the search result can be narrowed-down relatively significantly by the invention, the user's task in the possible subsequent manual selection of one of the media objects found is made easier.

Included under the invention are search requests that comprise the abovementioned or further representation-describing features individually or in any combination, in particular explicitly. Especially in a search for multimedia media objects, a search for media objects that is even more closely tailored to the needs of the user may thereby be undertaken.

The dependent claims each contain especially advantageous embodiments and further embodiments of the invention.

In order to match the search result even more closely to the user's requirements without increasing the involvement of the user, it is proposed that a representation-describing feature be automatically resolved into representation-describing detailed features. So, for instance, the representation-describing feature “suitable for children” may be resolved into the representation-describing detailed feature “action suitable for children”, “language suitable for children”, “acoustic representation suitable for children” and/or “visual representation suitable for children”. Another embodiment provides for these representation-describing detailed features themselves to be even more finely resolved. The representation-describing detailed feature “visual representation suitable for children” may then, for instance, be further resolved into the features “large print”, “clear print”, “large pictures”, “color pictures”, “many pictures”, “more drawings than photo-realistic pictures”. This embodiment is hereby based on the idea of finding the “lowest common denominator” between the search request and selectable media objects, i.e. resolving representation-describing features of selectable media objects and/or of a search request so finely into detailed features that, when compared, the features are at the same level of detailing.

The representation-describing features may be extracted from a user input in accordance with a further embodiment of the invention. This increases the convenience of the search and enables the user to be offered a search result matched to his wishes. The user may hereby proceed in a way such as he is used to with conventional search engines. If, for instance, the user input, in particular the inputting of a search request, is realized by a voice input exclusively, alternatively or in addition to a keystroke input, features reflecting his personality or his wishes as regards the representation of media objects to be sought may be derived from the voice and/or language of the user. For instance, in the case of the inputting of a search request with a child's voice, the representation-describing feature “suitable for children” may be extracted and used as a component part of the search request. The extraction of the representation-describing features may hereby be realized at the user's location, in a central facility of a communications network or at the location of the supplier of media objects. Calculation operations may be saved if parameters that are determined in any event for the purpose of voice recognition in the context of speech input are used for extracting the representation-describing features from the voice and/or the language of the user.

Alternatively or in addition to the said extraction of features, provision may be made for a user profile to be stored in a user-profile memory facility, in which user profile representation-describing features corresponding to the user's wishes are stored. This user-profile memory facility may hereby be executed either centrally as a part of a communications network, locally in a subscriber station of the user or in a mobile memory device, such as a subscriber identification module. When a search request is inputted, the representation-describing features may then be retrieved automatically from the user-profile memory facility and, if applicable, combined with other features of the search request. If, at the end of the search procedure, a user manually selects a media object from the search result, the representation-describing features that describe this selected media object may be used as feedback information for updating or optimizing the user profile. When further search requests are made, this again leads to the search result being further matched to the user's wishes automatically, in particular in a manner invisible to the user.

It is especially preferred if provision is made for representation-describing features to be extracted from the media objects so that they can then be compared with the representation-describing features of the search request. The extraction of these representation-describing features may hereby take place in advance, for instance before or during the storage of the media objects. The media objects may then be stored with the representation-describing features associated with them. This has the advantage that the analysis effort for the extraction of the representation-describing features only occurs once and the analysis result, i.e. the representation-describing features, may be used over and over again for comparison with many different search requests. The title of the media objects and the associated representation-describing features may additionally be stored in a media-object directory remote from the media objects. As an alternative or in addition to the storage of the representation-describing features, it is possible for the representation-describing features of the media objects to be newly extracted for each search request. The memory requirement can be reduced as a result.

In addition to at least one representation-describing feature, the search request should preferably comprise at least one content-describing feature. The term content describing feature refers to features that describe the content of a media object, i.e. features that generally form the search requests for conventional search engines. This mainly involves headwords that describe the title, author, composer or subject of a media object.

In order to compare the representation-describing and content-describing features of a search request with the representation-describing and content-describing features of a large number of media objects, in particular a one-step method and a two-step method fall within the scope of the invention.

Under the one-step method, in a single step, the representation-describing and content-describing features of the search request are compared with the features of a large number of selectable media objects, degrees of correspondence between the search request and media objects are determined therefrom and, on the basis of these degrees of correspondence, a search result is organized. The selectable media objects may be, in particular, all media objects available to the user. The advantage of the one-step method lies, in particular, in the fact that little temporary memory is needed, and in the fact that an extremely good correspondence of the representation-describing features can cancel out a low correspondence of the content-describing features.

By contrast, under the two-step method, only content-describing features of the search request are initially compared with the features of a large number of media objects in a first step, degrees of correspondence for selection in respect of the content are determined therefrom between the search request and media objects and, based on these degrees of correspondence for selection, a large number of selectable media objects is selected from media objects generally available to the user. A predetermined number of media objects may hereby be selected that exhibit the greatest degrees of correspondence for selection with the search request. As an alternative to this, selection may be made of the media objects that exhibit a degree of correspondence with the search request that exceeds a predetermined limiting degree of correspondence for selection. These selected media objects now form the selectable media objects for a second step, in which features of the selectable media objects are compared with the representation-describing features of the search request, degrees of correspondence are determined therefrom and, on the basis of these degrees of correspondence, a search result is organized. The degrees of correspondence for selection as determined in the first step may also be incorporated into this organization of the search result. Since the comparison of content-describing features with one another is generally less complex than the comparison of representation-describing features with one another, the two-step method has the advantage that only pre-selected media objects with a content that already complies with the user's wishes are allowed to be subject to the complex comparison with representation-describing features.

A system of searching for media objects by the method in accordance with the invention possesses a media interface for access to selectable media objects, a request interface for receiving a search request from a user, a comparison device set up in such a way that, in order to determine degrees of correspondence between the search request and selectable media objects, at least one feature of the search request is compared with at least one feature of the selectable media objects, wherein the search request comprises at least one representation-describing feature, and one organizational device set up in such a way that a search result based on the degrees of correspondence is organized.

This system may be implemented in practice either wholly or in part on a central device of a communications network, at a user's home or at the location where media objects are stored. For instance, the media interface, the request interface, the comparison device and/or the organizational device may be realized within a personal computer or a user's home entertainment system. In this event, the media interface enables, for instance, an access to locally stored media objects, and the request interface is, for instance, set up to receive a search request from an inputting device. Instead of, or in addition to this, it is possible, for example, for a media interface and/or a request interface to form the components of a search computer, which is connected via the Internet to memory devices for media objects and to an inputting device located at the user's location. The comparison device and the organizational device may hereby form further components of the search computer. It is also possible for the media interface, the request interface, the comparison device and/or the organizational device to be localized at the location of the memory device, namely at a commercial supplier of media objects, and connected via the Internet to an inputting device for converting the user inputs into a search request. Transmitted hereby via the media interface may be either the media objects themselves and/or information concerning the media objects, such as the titles of media objects, associated content and representation-describing features and/or the memory address or Internet address of the media objects.

The system of searching for media objects may be further developed as claimed in the claims relating to the method.

The invention will be further described with reference to examples of embodiments shown in the drawings, to which, however, the invention is not restricted.

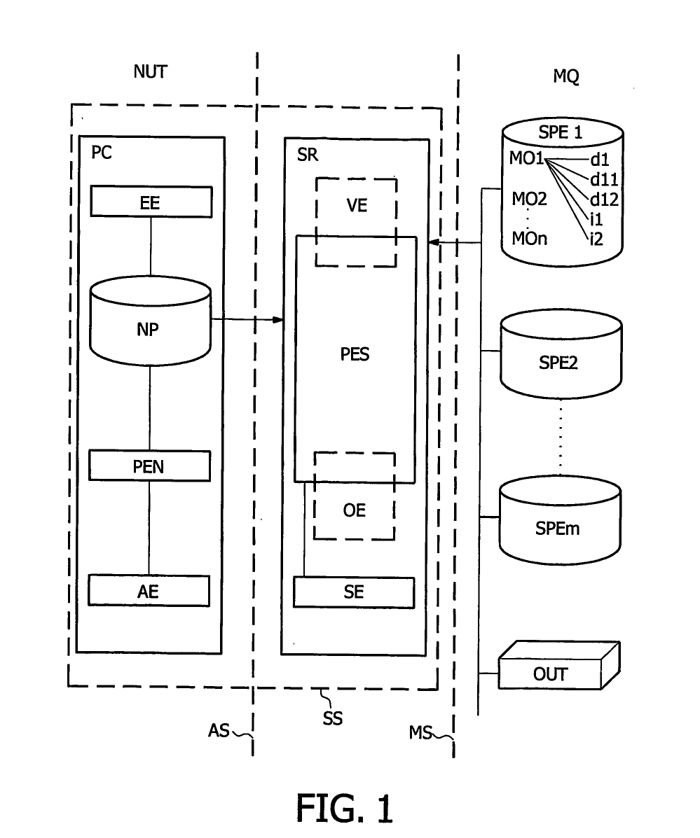

FIG. 1 shows a simplified schematic diagram of the system architecture of a system of searching for media objects with media-object sources.

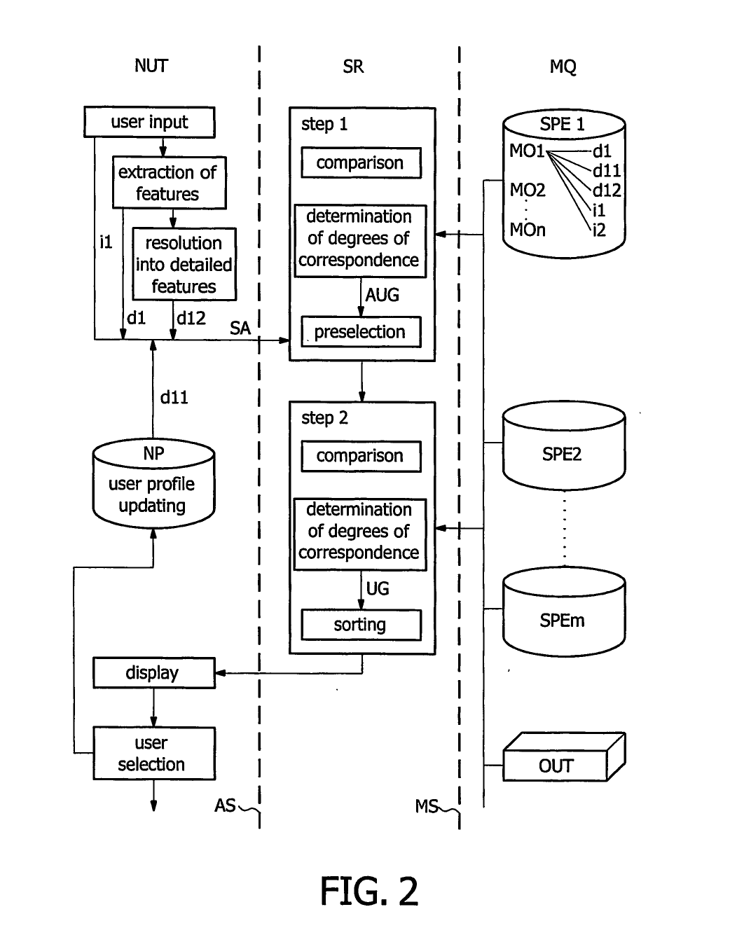

FIG. 2 shows a flowchart regarding the search for media objects.

FIGS. 1 and 2 each show, to the left of the left-hand broken line representing the request interface AS, the user side NUT of the system, to the right of the right-hand broken line representing the media interface MS, the media-object sources MQ, and, between the two broken lines, respectively, a search computer SR, which is the core of the system, and the method steps performed with the aid of the search computer SR. Identical reference codes in the two Figures hereby indicate identical elements. In particular, only the most important components of the system's hardware configuration are shown in FIG. 1 for the sake of clarity. It is obvious that this system is also equipped with all other components that normally belong to search systems of this kind, such as suitable connection leads, bus systems or routers.

The hardware configuration of the system SS will first be described with reference to FIG. 1, and then a search method and the associated method steps will be explained with reference to FIG. 2.

FIG. 1 shows, as a component of a system SS of searching for media objects, a personal computer PC as the user's communications terminal and a search computer SR.

The personal computer PC comprises a keyboard and a microphone as the inputting device EE, and a graphics display and a loudspeaker as the outputting device AE. The personal computer further comprises a memory device NP for storing a user profile, in particular for storing the representation-describing features preferred by the user. The personal computer PC is connected to the search computer SR via a request interface AS. The components of the personal computer and the methods executed by the personal computer are controlled by a program-controlled processor device PEN, which may be equipped with further memory elements.

The search computer SR, which may also be realized by a personal computer, comprises a comparison device VE and an organizational device OE, which are realized, wholly or at least in part, by a program-controlled processor device PES. In addition to the processor device PES, the search computer comprises hard-disk and/or semiconductor memory elements SE for storing program software, intermediate search results and directories of media objects. The directories of media objects hereby comprise the titles of media objects, content-describing and/or representation-describing features associated with the media objects and Internet addresses of the associated media-object sources. The search computer SR is connected via a media interface MS to a large number of media sources MQ to which it has access, including read access, via the media interface MS.

The media-object sources MQ are realized by hard-disk memory devices SPE1, SPE2, . . . SPEm, the content of which is organized by structures similar to databases, and by at least one recording studio AUS for the production of live radio drama programs. The hard-disk memory devices SPE1, SPE2, . . . SPEm each comprise a large number of media objects MO1, MO2, . . . MOn (shown as an example only for SPE1), which are stored with the inclusion of the associated representation-describing features d1, the associated representation-describing detailed features d11, d12 and the associated content-describing features i1, i2 (shown as an example only for MO1).

Explained below with reference to FIG. 2 is a search method in which, as the user, a child is searching the Internet for the media object “The Fairy Tale of Snow White”.

The child firstly enters the words “Snow White” using voice inputting as his user input. A voice analysis device converts these spoken words into a search request with the content-describing feature i1 “Snow White”. In addition, by means of an extraction of features, it is determined with the voice analysis device that the user input is a child's voice, and the representation-describing feature d1 “suitable for children” is thus extracted. This feature “suitable for children” is resolved inter alia into the detailed feature d12 “action suitable for children” by resolution into representation-describing detailed features. In addition, the detailed feature d11 “woman's voice as narrator” is read from the child's user profile, because it has proved in the past that the child prefers to have fairy tales read by a woman's voice. A search request SA comprising the features “Snow White”, “suitable for children”, “action suitable for children” and “woman's voice as narrator” is then sent to a search computer SR over the Internet as the request interface AS.

Initially, in a first step, the available media objects, listed in a multi-object directory, and in particular the content-describing features associated with them, are compared by the search computer SR with the content-describing feature i1 “Snow White” of the search request, and degrees of correspondence for selection AUG between the search request and the available media objects are determined therefrom. The media-object directory hereby represents a kind of contents list of the media-object sources without containing the media objects themselves. The media objects with the twenty largest degrees of correspondence are sent as selectable media objects to a second step in the course of a preselection.

In the second step, the selectable media objects, and in particular the representation-describing features associated with them, are compared with the representation-describing (detailed) features “suitable for children”, “action suitable for children”, and “woman's voice as narrator” of the search request, and degrees of correspondence UG between the search request and the selectable media objects are determined therefrom. As a function of the degrees of correspondence thereby determined, the selectable media objects are then sorted and the search result organized in this way is transmitted via the Internet to the child's personal computer. Via an output device, the child is initially shown a sorted list with the titles of the twenty media objects, each with a brief further description, or offered it to try with a brief media excerpt. The child can then, as part of a user selection, manually select the media object that best accords with his wishes. This media object can then be downloaded in further steps, which are not shown in the Figure, from the relevant media-object source via the Internet to the personal computer, and output there. If the child ultimately manually selects a fairy tale spoken in a man's voice, the user profile will be updated, in the course of a user-profile updating procedure, to the effect that the representation-describing detailed feature “woman's voice as narrator” is replaced by the detailed feature “man's voice as narrator” or deleted, or downgraded in priority.

From time to time, the media-object directory is updated in the search computer to the effect that the available media-object sources are interrogated as to their content or their offering, and corresponding entries in the media-object directory are corrected or supplemented. To this end, depending on the embodiment, the media-object titles in the media-object directory either have assigned to them the content-describing or representation-describing features that are already assigned to the corresponding media objects in the media-object sources, or these content-describing or representation-describing features are extracted from the media objects and only then assigned to the corresponding media-object titles in the media-object directory.

In conclusion, it is again pointed out that the systems and methods illustrated in the Figures and the descriptions are merely embodiment examples, which may be varied to a large degree by a person skilled in the field without exceeding the bounds of the invention. For instance, in the above-described embodiment examples, the request interface and the media interface were realized, in particular, by an Internet connection. These interfaces may, however, also be based on other communications protocols or on standardized or proprietary data bus protocols. The media-object sources may also be components of the search computer. It is further possible for the media objects to be transferred to the user indirectly via the search computer from the media-object sources, rather than directly via the Internet, as a result of which billing and digital rights management systems may be superimposed on the search method. It is also possible for the personal computer and the search computer to be executed together as a computing unit. For the sake of completeness, it is also pointed out that the use of the indefinite article “a” does not exclude the possibility that the features in question may also be present more than once, and that the use of the term “comprehensive” does not preclude the existence of further elements or steps.

1. A method of searching for media objects
in which, in order to establish degrees of correspondence (UG) between a search request (SA) and selectable media objects, at least one feature (i1, d1, d11, d12) of the search request (SA) is compared with at least one feature of the selectable media objects,
in which the search request comprises at least one representation-describing feature (d1) and
in which a search result based on the degrees of correspondence (UG) is organized.

2. A method as claimed in claim 1, characterized in that the search result is sorted on the basis of the degrees of correspondence (UG).

3. A method as claimed in claim 1, characterized in that, in order to establish the degrees of correspondence, at least one representation-describing feature (d1) is resolved into representation-describing detailed features (d11, d12).

4. A method as claimed in claim 1, characterized in that at least one representation-describing feature (d1) of the search request is extracted from a user input.

5. A method as claimed in claim 4, characterized in that, with the use of an acoustic inputting device, at least one representation-describing feature (d1) of the search request is extracted from the user input by means of voice analysis.

6. A method as claimed in claim 1, characterized in that at least one representation-describing feature (d1) is explicitly described by the user input.

7. A method as claimed in claim 1, characterized in that representation-describing features (d1) are extracted from at least some of the selectable media objects.

8. A method as claimed in claim 1, characterized in that at least some of the selectable media objects are stored, with associated representation-describing features (d1) in a memory facility (SPE1, SPE2, . . . SPEm).

9. A method as claimed in claim 1, characterized in that the search request (SA) comprises at least one content-describing feature (i1, i2).

10. A method as claimed in claim 9, characterized in that
initially, in order to determine degrees of correspondence for selection (AUG) between a search request (SA) and the available media objects (MO1, MO2 . . . MOn), at least one content-describing feature (i1, i2) of the search request (SA) is compared with at least one feature of the available media objects (MO1, M02, . . . MOn), and
that the selectable media objects are selected from the available media objects as a function of the degrees of correspondence for selection (AUG).

11. A system (SS) of searching for media objects, with
a media interface (MS) for access to selectable media objects,
a request interface (AS) for receiving a search request from a user,
a comparison device (VE) set up in such a way that, in order to determine degrees of correspondence (UG) between the search request (SA) and selectable media objects, at least one feature of the search request is compared with at least one feature of the selectable media objects, wherein the search request (SA) comprises at least one representation-describing feature, and
an organizational device (OE) set up in such a way that a search result based on the degrees of correspondence is organized.

12. A system (SS) as claimed in claim 11 with an inputting device (EE) for converting a user input into a search request comprising at least one representation-describing feature.
